(19) United States
(12) Patent Application Publication
(10) Pub. No.: US 2013/0048815 A1
(43) Pub. Date: Feb. 28, 2013

(54) SYSTEM AND METHOD FOR INSTALLATION OF PHOTOVOLTAIC MODULES

(71) Applicants: Christian Joseph Wagner, Latham, NY (US); Neil Anthony Johnson, Schenectady, NY (US); Charles Steven Korman, Niskayuna, NY (US); Donald Michael Doherty, Schenectady, NY (US)

(72) Inventors: Christian Joseph Wagner, Latham, NY (US); Neil Anthony Johnson, Schenectady, NY (US); Charles Steven Korman, Niskayuna, NY (US); Donald Michael Doherty, Schenectady, NY (US)

(73) Assignee: GENERAL ELECTRIC COMPANY, SCHENECTADY, NY (US)

(21) Appl. No.: 13/220,768

(22) Filed: Aug. 30, 2011

(51) Int. Cl. F16M 11/00; B23P 17/04

(52) U.S. Cl. 248/228.1; 29/525.01

(57) ABSTRACT

A mounting system is presented. An embodiment of a mounting system that includes a support platform configured to fasten the mounting system to a mounting surface. The mounting system further includes a stud operatively coupled to the support platform and disposed substantially perpendicular to the support platform. In addition, the mounting system includes an elevating unit operatively coupled to the stud, wherein the elevating unit includes a fastener operatively coupled to one end of the stud and configured to vary a height of the mounting system, and a rail-clip coupled to the fastener, wherein a rotational motion of the rail-clip is independent of a rotational motion of the fastener. Furthermore, the mounting system includes a rail operatively coupled to the rail-clip and configured to support at least one module.

### BACKGROUND

The disclosure relates generally to installation of photovoltaic modules and more specifically to a mounting system adapted for use in installation of photovoltaic modules.

Photovoltaic systems offer a clean and renewable source of energy. Critical factors in usage and adoption of photovoltaic cells as a supplementary or primary power source include cost to end users and ease of installation. In residential environments, photovoltaic modules are typically installed on house roofs or other suitable surfaces that provide optimal exposure to sunlight.

Installation of photovoltaic modules typically requires elaborate fitting equipment and installation procedures. A significant number of parts are required for complete installation of a residential photovoltaic module array. Typically, mounting equipment is one of the fitting equipment that plays a key role in the installation of photovoltaic modules on a house roof. Conventional mounting equipment or the mounting system is used to support the photovoltaic modules at a top end and a base end is fastened to a mounting surface or rafters of the roof.

One drawback of the installations that use a conventional mounting system is that one lag bolt is required for each mounting plate that is fastened to the mounting surface. As will be appreciated, some of the lag bolts may be disposed at an angle that is not perpendicular to the rafter of the roof. The severity of the angle and the trajectory of the lag bolt that penetrates into the rafter of the roof could cause the rafter to split. This splitting of the rafter unfortunately reduces the structural integrity of the mounting system.

Additionally, the conventional mounting system includes rigid components, which require effective tools to adjust or modify a height of the mounting system on an uneven roof surface/deck. Moreover, since the conventional mounting system typically entails use of a high number of components, installation of the mounting system at a residential site is a time consuming and laborious process. Furthermore, manufacturing costs and installation costs increase significantly as the number of components/parts is increased. Such high costs are a barrier to the widespread usage and adoption of photovoltaic cells as power sources.

It is therefore desirable to develop a mounting system that is less expensive to manufacture and easy to install. Particularly, it is desirable to develop a mounting system with fewer components that facilitates tool-less installation and/or adjustment of the mounting system on any kind of roof surface.

### BRIEF DESCRIPTION

Briefly in accordance with one aspect of the technique, a mounting system is presented. The mounting system includes a support platform configured to fasten the mounting system to a mounting surface. The mounting system further includes a stud operatively coupled to the support platform and disposed substantially perpendicular to the support platform. In addition, the mounting system includes an elevating unit operatively coupled to the stud, wherein the elevating unit includes a fastener operatively coupled to one end of the stud and configured to vary a height of the mounting system, and a rail-clip coupled to the fastener, wherein a rotational motion of the rail-clip is independent of a rotational motion of the fastener. Furthermore, the mounting system includes a rail operatively coupled to the rail-clip and configured to support at least one module.

In accordance with a further aspect of the present technique, a method for assembling a mounting system is presented. The method includes fastening a support platform to a mounting surface. Also, the method includes disposing a stud on the support platform such that the stud is disposed substantially perpendicular to the support platform. The method further includes coupling an elevating unit to one end of the stud, wherein the elevating unit includes a fastener operatively coupled to the stud, and a rail-clip coupled to the fastener, wherein a rotational motion of the rail-clip is independent of a rotational motion of the fastener. The method also includes coupling at least a portion of a rail to the elevating unit. In addition, the method includes adjusting, by the fastener, a height of the mounting system independent of the coupling of the portion of the rail to the elevating unit.

In accordance with another aspect of the present technique, a mounting system for supporting an array of modules on a mounting surface is presented. The mounting system includes a support platform configured to fasten the mounting system to the mounting surface. Further, the mounting system includes a stud having a first end and a second end, wherein the first end is coupled to the support platform such that the stud is disposed substantially perpendicular to the support platform. Also, the mounting system includes an elevating unit coupled to the second end of the stud, wherein the elevating unit includes a fastener operatively coupled to the second end of the stud, and configured to rotate on the stud to vary a height of the mounting system. The elevating unit further includes a rail-clip coupled to the fastener, wherein the rail-clip comprises an aperture that allows the stud to protrude through the elevating unit. The elevating unit also includes a snap ring disposed along the circumference of the aperture in the rail-clip and configured to allow the rotational motion of the rail-clip that is independent of the rotational motion of the fastener. In addition, the method includes a rail operatively coupled to the rail-clip and configured to support the array of modules.

### DRAWINGS

These and other features, aspects, and advantages of the present invention will become better understood when the following detailed description is read with reference to the accompanying drawings in which like characters represent like parts throughout the drawings, wherein:

FIG. 1 is a front view of a mounting system supporting photovoltaic modules, in accordance with aspects of the present technique;

FIG. 2 is a perspective view of a stud and a support platform of the mounting system of FIG. 1, in accordance with aspects of the present technique;

FIG. 3 is a perspective view of a rail-clip, the stud, and the support platform of the mounting system of FIG. 1, in accordance with aspects of the present technique;

FIG. 4 is a perspective view of the mounting system of FIG. 1, in accordance with aspects of the present technique.

FIG. 5 is a perspective view of the mounting system of FIG. 1 supporting photovoltaic modules, in accordance with aspects of the present technique; and

FIG. 6 is a flow chart illustrating a method for assembling the mounting system, in accordance with aspects of the present technique.

### DETAILED DESCRIPTION

As will be described in detail hereinafter, various embodiments of an exemplary mounting system for use in installation of photovoltaic modules and methods for assembling the mounting system are presented. By employing the methods and mounting system described hereinafter, manufacturing cost and cost of installing the photovoltaic modules on a mounting surface may be substantially reduced.

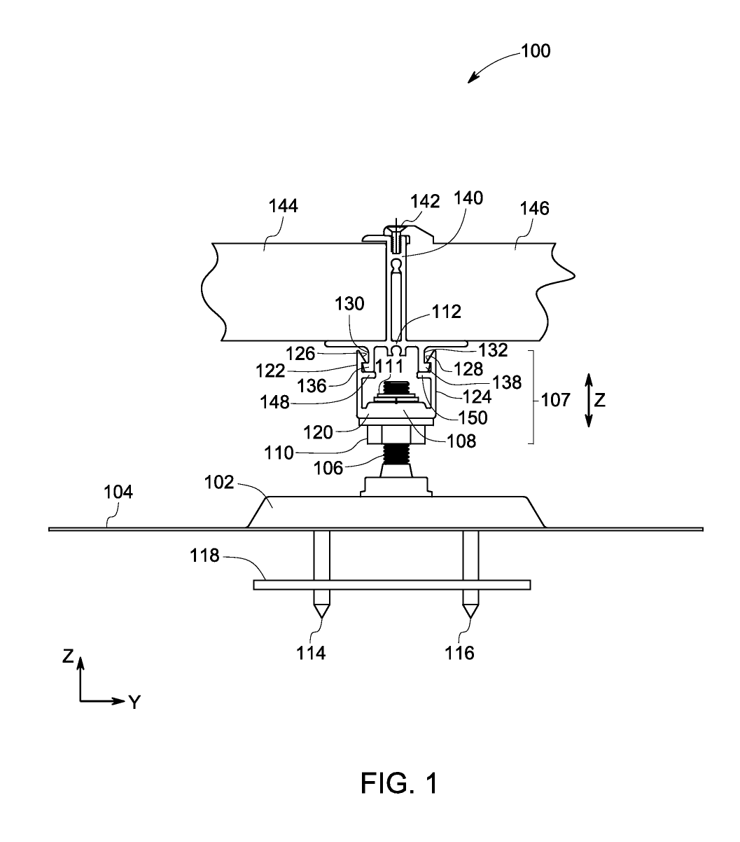

Turning now to the drawings, and referring to FIG. 1, a front view of a mounting system 100 supporting a pair of photovoltaic modules, in accordance with aspects of the present technique, is depicted. The mounting system 100 is typically employed for elevating and/or supporting objects such as solar panels and satellite dishes upon roof tops of residential and commercial buildings. The solar panels may include an array of photovoltaic modules that offer a clean and renewable source of energy. The mounting system 100 includes components, such as a support platform 102, a stud 106, an elevating unit 107, and a rail 112, in certain embodiments.

Further, in one embodiment, the support platform 102 is a flat structure that is disposed on a mounting surface 104. The “mounting surface” could be, for example, a roof deck upon which the photovoltaic modules are installed. For example, the surface may be an even and/or uneven roof surface, a building surface, or any concrete surface, suitable for installation of solar or photovoltaic modules. Also, one or more rafters 118 may be employed to provide structural support to the mounting surface 104. The term “rafter” is used to refer to a beam that provides structural support to the mounting surface 104 of a building or a house, for example. The rafter may include a wooden beam or an iron beam. In certain embodiment, the one or more rafters 118 may be disposed or located below the mounting surface 104.

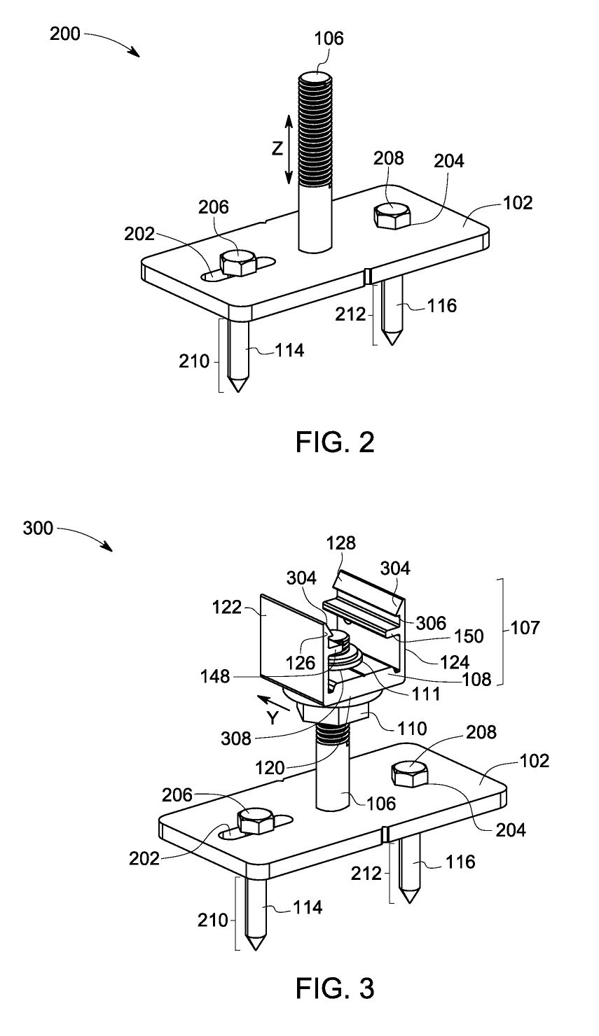

In a presently contemplated configuration, the support platform 102 includes a pair of apertures (shown in FIG. 2) on either side of the support platform 102. The apertures are used to fasten the support platform 102 to the mounting surface 104. In one example, a first joint 114 is inserted through a first aperture (shown in FIG. 2) of the support platform 102 and through the rafter 118 of the mounting surface 104. Similarly, a second joint 116 is inserted through a second aperture (shown in FIG. 2) of the support platform 102 and through the rafter 118 of the mounting surface 104. Each of these joints 114, 116 includes a head portion and a tail portion, where the head portion is positioned above or in line with the support platform 102 and the tail portion penetrates the mounting surface 104 and/or the rafter 118. The aspect of fastening the support platform 102 to the mounting surface 104 will be explained in greater detail with reference to FIG. 2.

As previously noted, in a conventional mounting system, one lag bolt may be employed to fasten the mounting system to the roof deck. Also, the lag bolt may be drilled at different angles to the roof rafter, which may cause the rafter to split. Moreover, since only one lag bolt is employed, the split in the rafter may unfortunately reduce the structural integrity of the mounting system. Some or all of these shortcomings of the currently available mounting systems may be circumvented via use of embodiments consistent with the example mounting system 100. Particularly, in accordance with aspects of the present technique, the two joints 114, 116 can be employed to fasten the support platform 102 to the mounting surface 104. Moreover, the two joints 114, 116 can be drilled at two ends of the support platform 102 to penetrate into the mounting surface 104 and/or the rafter 118. Also, the joints 114, 116 can be drilled at an angle that is substantially perpendicular to the mounting surface 104 and/or the rafter 118, thereby potentially reducing the likelihood any splitting of the rafter 118 and enhancing the structurally integrity of the coupling of the mounting system 100 with the mounting surface or roof surface 104.

In accordance with exemplary aspects of the present technique, the support platform 102 may be rigidly coupled to the stud 106. Particularly, the center portion of the support platform 102 between the two apertures may be utilized to fasten the stud 106 to the support platform 102. For example, a first end of the stud 106 may be fastened or inserted into the center portion of the support platform 102 such that the stud 106 is rigidly coupled to the support platform 102. Furthermore, the stud 106 can be disposed substantially perpendicular to the support platform 102. In one embodiment, the support platform 102 and the stud 106 may be molded together to form a single entity or component of the mounting system 100.

In one embodiment, the stud 106 includes a cylindrical rod with spiral threads on an outer surface of the stud 106. The stud 106 includes the spiral threads from a first end of the stud 106 to a second end of the stud 106. Also, these spiral threads facilitate rotation of a fastener 110 along the stud 106 from the first end to the second end of the stud 106 and vice versa. It may be noted that the terms “stud” and “threaded stud” may be used interchangeably. In one embodiment, the stud 106 may have a height in a range from about 2 inches to about 4 inches.

Further, the other end of the stud 106 is coupled to the elevating unit 107. Particularly, the second end of the stud 106 is coupled to the elevating unit 107. The elevating unit 107 is configured to support the rail 112. The elevating unit 107 includes a rail-clip 108, the fastener 110, and a snap ring 111. The fastener 110 is coupled to the stud 106. In one example, the fastener 110 is coupled to the second end of the stud 106. Further, the fastener 110 is configured to rotate over the spiral threads of the stud 106 to adjust or vary a height of the mounting system 100 in a Z-direction. For example, by rotating the fastener 110 over the spiral threads of the stud 106, the height of the elevating unit 107 is varied, which in turn varies the height of the rail 112 relative to the mounting surface 104.

Moreover, the rail-clip 108 is coupled to the fastener 110. Specifically, in one embodiment, the rail-clip 108 is coupled to the fastener 110 via the snap ring 111. In one embodiment, the snap ring 111 may be disposed along a circumference of an aperture in the rail-clip 108. The snap ring 111 may include a bearing ring that allows the rotational motion of the fastener 110 to be independent of the rotational motion of the rail-clip 108. For example, the fastener 110 may be rotated on the stud 106 while the rail-clip 108 is maintained at a stationary position. This ability of the fastener 110 to be rotated independent of any rotational motion of the rail-clip 108 aids in adjusting the height of the mounting system 100 even when the rail 112 is mounted over the rail-clip 108. That is, the height of the mounting system 100 may be adjusted regardless of the mounting of the rail 112 over the rail-clip 108.

In accordance with aspects of the present technique, the rail-clip 108 includes a base-wall 120 and a pair of side walls 122, 124. The base-wall 120 and the side walls 122, 124 are molded together to form a C-shaped structure in certain embodiments. Further, a first end of the base-wall 120 is coupled to the fastener 110, as depicted in FIG. 1. Moreover, the aperture at the center of the base-wall 120 is aligned with the fastener 110 that is coupled to the first end of the base-wall 120. More specifically, the aperture in the base-wall 120 is aligned with a cavity of the fastener 110 so that the threaded stud 106 protrudes through the aperture in the base-wall 120 when the fastener 110 is rotated over the threaded stud 106 in a downward direction.

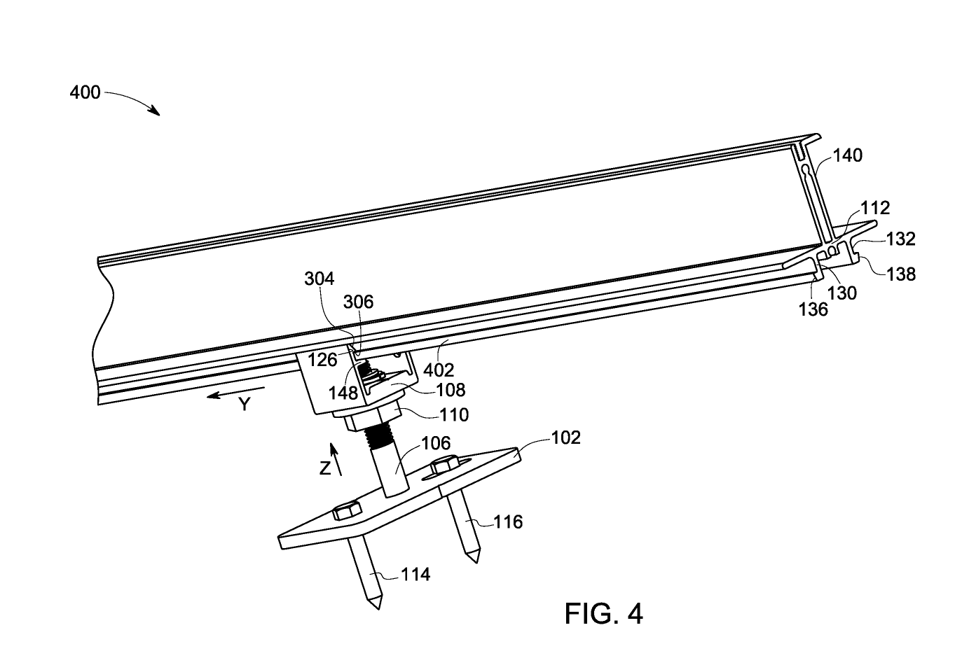

In a presently contemplated configuration, the pair of side walls, such as a first side wall 122 and a second side wall 124, is disposed on a second end of the base-wall 120 to form the C-shaped structure. Furthermore, the first side wall 122 includes a first protruding portion 126 and a first ridged portion 148. The first protruding portion 126 extends inward from a distal end of the first side wall 122 relative to the base-wall 120. The term “distal end” may be used to refer to an end of the side wall 12 that is farther from the base-wall. Further, the first ridged portion 148 extends inward from the first side wall 122 at a determined distance below the first protruding portion 126, as depicted in FIG. 1. Similarly, the second side wall 124 also includes a second protruding portion 128 and a second ridged portion 150. The second protruding portion 128 extends inward from a distal end of the second side wall 124 relative to the base-wall 120. Also, the second ridged portion 150 extends inward from the second side wall 124 at a determined distance below the second protruding portion 128, as depicted in FIG. 1. Both the protruding portions 126, 128 and the ridged portions 148, 150 are symmetrically arranged on the side walls 122, 124 to form a track area for sliding the rail 112 along a Y-direction. Particularly, a surface area of the ridged portions 148, 150 facing the protruding portions 126, 128 and a surface area of the side walls 122, 124 between the protruding portions 126, 128 and the ridged portions 148, 150 together form the track area for a lateral movement or a Y-axis movement of the rail 112, as depicted in FIG. 1. This lateral movement of the rail 112 on the rail-clip 108 will be explained in greater detail with reference to FIG. 4.

In addition to the lateral movement of the rail 112, the rail-clip 108 also allows a longitudinal movement or Z-axis movement of the rail 112. This longitudinal movement of the rail 112 is obtained by rotating the fastener 110 of the elevating unit 107 on the threaded stud 106. As previously noted, rotating the fastener 110 on the threaded stud 106 results in the longitudinal movement of the rail-clip 108 in the Z-direction. The movement of the rail-clip 108 in the Z-direction in turn causes a similar movement of the rail 112 relative to the support platform 102 since the rail-clip 108 is coupled to the rail 112. Particularly, the fastener 110 coupled to the rail-clip 108 is rotated on the stud 106 to adjust the height of the rail 112 from the support platform 102. Thus, the exemplary mounting system 100 facilitates both the lateral movement and the longitudinal movement of the rail 112.

In accordance with aspects of the present technique, the rail-clip 108 is configured to couple at least a portion of the rail 112 to the rail-clip 108. In one example, the rail-clip 108 is configured to mechanically snap at least a portion of the rail 112 into the rail-clip 108. Particularly, the rail 112 includes a pair of parallel beams and an I-beam. The I-beam is disposed at a first end of the rail 112 and the pair of parallel beams is disposed at a second end of the rail 112. These parallel beams, such as a first beam 130 and a second beam 132 are configured to mate with the rail-clip 108 when the rail 112 is inserted or snapped into the rail-clip 108. More specifically, the first beam 130 includes a first wedge 136 that extends outward at a distal end of the first beam 130, as depicted in FIG. 1. The term “distal end” may be used to refer to an end of the beams 130, 132 that is farther from the I-beam. Similarly, the second beam 132 includes a second wedge 138 that extends outward at a distal end of the second beam 132, as depicted in FIG. 1. These first and second wedges 136, 138 are configured to couple or lock with a corresponding protruding portion 126, 128 of the rail-clip 108 when the beams 130, 132 are snapped into the rail-clip 108. For example, when the first beam 130 is inserted into the rail-clip 108, the first wedge 136 mates or locks with the first protruding portion 126. Similarly, when the second beam 132 is inserted into the rail-clip 108, the second wedge 138 mates or locks with the second protruding portion 128.

As will be appreciated, in a conventional mounting system, a strut may typically be positioned at a top end of the mounting system for supporting or holding the photovoltaic modules, for example. This strut may be coupled to the base of the mounting system by inserting a lag bolt through the strut and tightening the lag bolt by a fastener. Since the strut is coupled to the base by employing the bolt and fastener, the time and the labor cost for installation of photovoltaic modules may be substantial. Some or all of these shortcomings of the currently available mounting system may be circumvented via use of the exemplary mounting system 100. Particularly, in accordance with aspects of the present technique, the rail 112 can be simply snapped into the rail-clip 108 without intervention of a fastener and a bolt. This may advantageously reduce the labor cost and installation time of the mounting system 100.

Furthermore, the I-beam 140 may be formed by coupling two C-channels back-to-back. The I-beam 140 is configured to support the photovoltaic modules 144, 146. Each of the C-channels in the I-beam 140 is employed to support one or more photovoltaic modules. Also, a rail pin 142 is coupled to one end of the I-beam 140. This rail pin 142 aids in tightening the C-channels of the I-beam 140 that supports the photovoltaic modules, such as a first photovoltaic module 144 and a second photovoltaic module 146. Although, the mounting system 100 of FIG. 1 is shown as supporting two photovoltaic modules 144, 146, it may be noted that the mounting system 100 may support a single photovoltaic module or an array of photovoltaic modules.

By employing the exemplary mounting system 100, the installation time and the installation cost of the photovoltaic modules 144, 146 may be substantially reduced relative to conventional mounting systems. Also, since relatively fewer components are used for assembling the mounting system 100, the mounting system 100 may be easily adjusted or modified with minimal labor cost. For example, on an uneven surface of the roof, the height of the mounting system 100 may be easily adjusted by rotating the fastener 110 of the elevating unit 107 on the threaded stud 106. Moreover, the exemplary mounting system 100 facilitates adjustment of the mounting system 100 without the use of tools or with use of relatively fewer tools. For example, an installer may easily rotate the fastener 110 or nut with his hand to adjust the height of the mounting system 100. In particular, the mounting system 100 may be adjusted without dismantling the rail 112 and/or photovoltaic modules 144, 146 from the mounting system 100.

FIG. 2 illustrates a perspective view 200 of a portion of the mounting system 100 of FIG. 1. Particularly, the support platform 102 and the stud 106 of the mounting system 100 of FIG. 1 are illustrated in FIG. 2. The support platform 102 includes two apertures such as a first aperture 202 and a second aperture 204 on either end of the support platform 102. These two apertures 202, 204 are employed in fastening the support platform 102 of the mounting system 100 to the mounting surface 104 (see FIG. 1). More specifically, the support platform 102 is fastened to the mounting surface 104 by inserting elongated joints 114, 116 through each of the apertures 202, 204 and through the mounting surface 104 and/or the rafter 118 (see FIG. 1). For example, the elongated joints 114, 116 may be a screw or a bolt that can be inserted into the mounting surface 104 and/or the rafter 118 through the apertures 202, 204 of the support platform 102.

In the example depicted in FIG. 2, the first joint 114 is inserted into the first aperture 202 of the support platform 102. By inserting the first joint 114 into the first aperture 202, a head portion 206 of the first joint 114 settles above or in line/level with the support platform 102. However, a tail portion 210 of the first joint 114 protrudes out of the support platform 102. Further, the protruding tail portion 210 of the first joint 114 is inserted into the mounting surface 104 so that the tail portion 210 of the first joint 114 is rigidly coupled to the mounting surface 104 and/or the rafter 118 that is positioned beneath the mounting surface 104. Thus, by employing the first joint 114, the side having the first aperture 202 is fastened to the mounting surface 104.

In a similar fashion, the second joint 116 is inserted into the second aperture 204 of the support platform 102 with a head portion 208 that settles above or in line with the support platform 102 and a tail portion 212 protruding from the support platform 102. Further, the protruding tail portion 212 of the second joint 116 is inserted into the mounting surface 104 to fasten the second joint 116 to the mounting surface 104 and/or the rafter 118 that is positioned beneath the mounting surface 104. Thus, the second joint 116 fastens the other side of the support platform 102 to the mounting surface 104. In one embodiment, the support platform 102 may be a mounting plate that is fastened to the mounting surface 104 at regular intervals for supporting an array of photovoltaic modules.

As previously noted with respect to FIG. 1, the mounting system 100 includes the stud 106 that can be disposed substantially perpendicular to the support platform 102. The stud 106 can be coupled to the support platform 102 at the center of the support platform 102 between the first aperture 202 and the second aperture 204, as depicted in FIG. 2. The stud 106 may be a cylindrical rod with spiral threads over the circumference of the rod. The spiral threads on the rod may be employed to facilitate longitudinal movement of the elevating unit 107 along the stud 106 from one end of the stud 106 to the other end of the stud 106 and vice versa. This movement of the elevating unit 107 helps in adjusting the height of the mounting system 100 upon which the photovoltaic modules 144, 146 are disposed. More specifically, the fastener 110 is rotated over the spiral threads of the stud 106 to position the elevating unit 107 at a desirable height of the mounting system 100. For example, the height of the mounting system 100 may be adjusted with respect to the other mounting systems (not shown in FIG. 2) installed on the mounting surface 104 to level an array of photovoltaic modules.

FIG. 3 is a perspective view 300 of the support platform 102, the stud 106, and the elevating unit 107 of the mounting system 100 of FIG. 1, in accordance with aspects of the present technique. The elevating unit 107 includes the rail-clip 108 and the fastener 110. The rail-clip 108 may include a C-shaped structure with an aperture 308 at the center. The C-shaped structure is formed with the base-wall 120 (see FIG. 1) and the two side walls 122, 124 (see FIG. 1). Further, the base-wall 120 includes the aperture 308 at the center. In one embodiment, the aperture 308 in the base-wall 120 is aligned with the fastener 110, as depicted in FIG. 3. In accordance with exemplary aspects of the present technique, the fastener 110 is coupled to the base-wall 120 using a bearing or snap ring 111. Particularly, the fastener 110 is operationally coupled to the base-wall 120 via the bearing ring or snap ring 111, thereby allowing a rotational motion of the fastener 110 that is independent of a rotational motion of the base-wall 120 of the rail-clip 108. For example, in one embodiment, at least a portion of the snap ring 111 is disposed along the circumference of the aperture 308 of the base-wall 120. Further, since the fastener 110 is coupled to the snap ring 111, the rotation of the fastener 110 will not cause any rotation of the base-wall 120. This arrangement advantageously allows the fastener 110 to be moved along the Z-direction along the threaded stud 106 even when the photovoltaic modules 144, 146 are installed or disposed on the rail 112, which in turn is operationally coupled to the rail-clip 108 of the mounting system 100.

The surface area of the side walls 122, 124 below the protruding portions 126, 128 may act as a channel for guiding the rail 112 along a Y-axis or in a direction that is substantially perpendicular to the threaded stud 106. Moreover, the surface area of the side walls 122, 124 below the protruding portions 126, 128 and the surface area of the ridged portions 148, 150 facing the protruding portions 126, 128 may together form the track area that allows for a lateral movement (Y-axis) of the rail 112, as depicted in FIG. 4. It may also be noted that in certain embodiments, the surface area of the base-wall 120 facing the protruding portions 126, 128 may form the track area that allows for the lateral movement (Y-axis) of the rail 112.

In addition, a portion 304 of the protruding portions 126, 128 may be tapered, as depicted in FIG. 3. Tapering of a portion of the protruding portions 126, 128 may aid in coupling the wedges 136, 138 (see FIG. 1) of the rail beams 130, 132 (see FIG. 1) to the ridged portions 148, 150 of the rail-clip 108. Subsequently, the wedges 136, 138 of the rail beams 130, 132 may be locked in place by a flat bottom surface 306 of the protruding portions 126, 128.

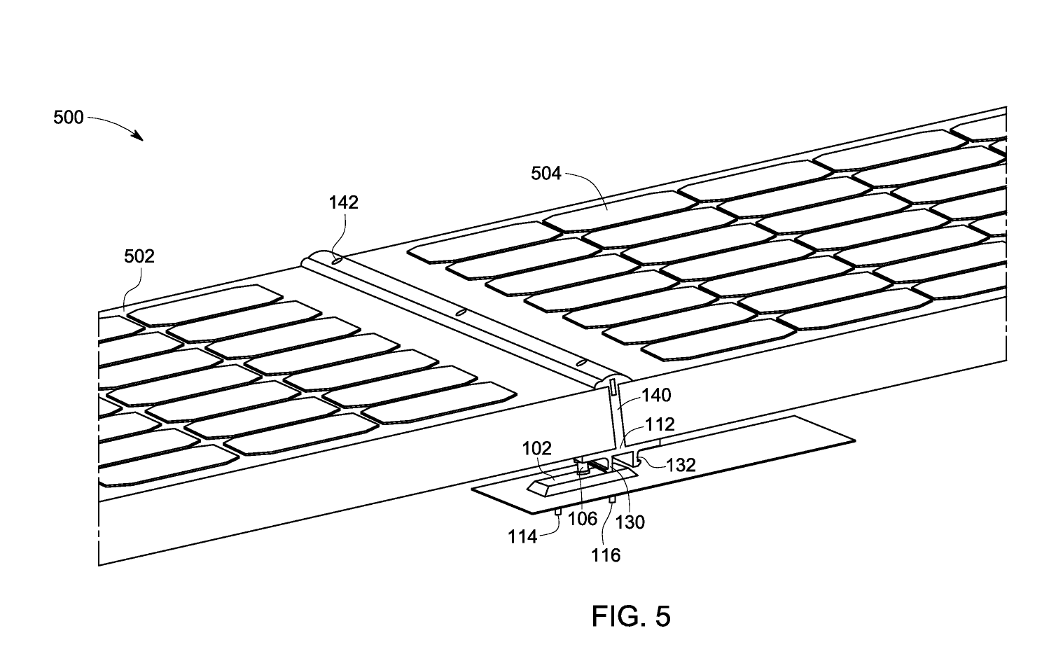

Turning now to FIG. 4, a perspective view 400 of the mounting system 100 of FIG. 1, in accordance with aspects of the present technique, is depicted. Particularly, the coupling of the rail 112 to the rail-clip 108 is illustrated in FIG. 4. As previously noted, the rail 112 includes two parallel beams, such as the first beam 130 and the second beam 132 at one end of the rail 112, and the I-beam 140 at the other end of the rail 112. The two parallel beams 130, 132 are configured in such a way that at least a portion of the beams 130, 132 locks with the rail-clip 108, as depicted in FIG. 4. The first beam 130 includes the first wedge 136 and the second beam 132 includes the second wedge 138, as previously noted. When the rail 112 is snapped into the rail-clip 108, the first wedge 136 having a tapered side 402 slides over the tapered side 304 of the first protruding portion 126 of the rail-clip 108 to mount the first beam 130 on the first ridged portion 148 of the rail-clip 108. Further, the first wedge 136 locks with the flat bottom surface 306 of the first protruding portion 126, as depicted in FIG. 4. Concurrently, the second wedge 138 having a tapered side (not shown in FIG. 4) slides over the tapered side (not shown in FIG. 4) of the second protruding portion 128 of the rail-clip 108 to mount the second beam 132 on the second ridged portion 150 of the rail-clip 108. The second wedge 138 locks with the flat bottom surface 306 of the second protruding portion 128. Since the beams 130, 132 are mounted on the ridged portions 148, 150 of the rail-clip 108 and the wedges 136, 138 of the beams 130, 132 are locked with the protruding portions 126, 128, the beams 130, 132 may be easily moved along the Y-axis to adjust the position of photovoltaic modules 144, 146 (shown in FIG. 1) on the mounting system 100. For example, the position of photovoltaic modules 144, 146 may be adjusted with respect to other modules in an array of modules (see FIG. 5).

In a presently contemplated configuration, the I-beam 140 at the other end of the rail 112 is configured to support photovoltaic modules 144, 146. The I-beam 140 is formed by two C-channels connected back-to-back, as depicted in FIG. 4. These C-channels are configured to support one or more photovoltaic modules 144, 146, as depicted in FIG. 5. Moreover, upon inserting the photovoltaic modules 144, 146 into the C-channels of the rail 112, rail-pins 142 (see FIG. 1) are inserted at regular intervals at a top end of the rail 112 to support the C-channels in holding the modules 144, 146.

FIG. 5 is a perspective view 500 of the mounting system 100 of FIG. 1 used to support photovoltaic units 502, 504, in accordance with aspects of the present technique. It may be noted that, in FIG. 5, the photovoltaic units 502, 504 include an array of photovoltaic modules, for example, 502, 504 may include arrays of photovoltaic modules, such as the first photovoltaic module 144 and the second photovoltaic module 146. These arrays of photovoltaic modules or photovoltaic units 502, 504 are disposed on two sides of the I-beam 140. The C-channel on each side of the I-beam 140 provides a platform for inserting the photovoltaic units 502, 504, as depicted in FIG. 5. In addition, the rail pins 142 are inserted into the rail 112 to aid the C-channels in supporting the photovoltaic units 502, 504. Thus, the rail 112 and the photovoltaic units 502, 504 may be easily installed on the mounting system 100, and specifically on the rail-clip 108, without using any tools.

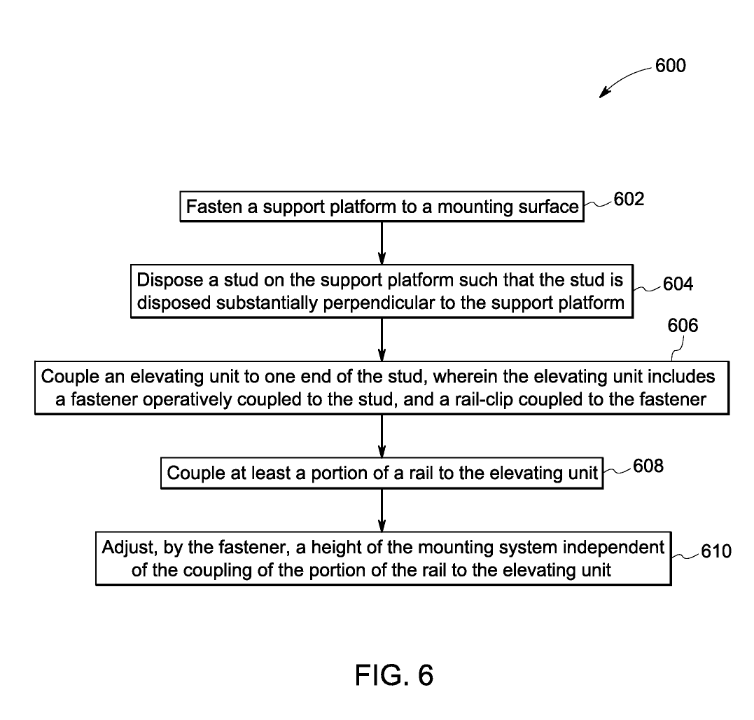

Referring now to FIG. 6, a flow chart 600 illustrating a method for assembling a mounting system, such as the mounting system 100 of FIG. 1, in accordance with aspects of the present technique, is depicted. For ease of understanding of the present technique, the method is described with reference to the components of FIGS. 1-5. The method begins at a step 602, where a support platform is fastened to the mounting surface (see FIG. 1). Particularly, the first joint 114 may be inserted into the first aperture 202 of the support platform 102, and the second joint 116 may be inserted into the second aperture 204 of the support platform 102. The first joint 114 and the second joint 116 are inserted at two opposite ends of the support platform 102 to fasten the support platform 102 to the mounting surface 104.

Subsequently, at step 604, the stud 106 is coupled to the support platform 102. The stud 106 may be a long cylindrical rod that is disposed substantially perpendicular to the support platform 102. The height of the cylindrical rod may be in a range from about 2 inches to about 4 inches. In one embodiment, the stud 106 may have spiral threads on the surface of the stud 106. These spiral threads on the stud 106 may be employed to translate the elevating unit 107 in a Z-direction.

Also, at step 606, the elevating unit 107 is coupled to one end of the stud 106. The elevating unit 107 includes the fastener 110 and the rail-clip 108. The fastener is rotated over the stud 106 to allow the elevating unit 107 to translate in the Z-direction. Moreover, the fastener 110 is coupled to the stud 106 at an end that is farther from the support platform 102. In addition, the rail-clip 108 is coupled to the fastener 110 through the snap ring 111. The snap ring 111 may be coupled to the circumference of the aperture of the rail-clip 108 and the fastener 110 may be coupled to the snap ring 111. The snap ring 111 allows a rotational motion of the rail-clip 108 that is independent of the rotational motion of the fastener 110. More specifically, the snap ring 111 may include a ball bearing ring that allows the fastener 110 to rotate on the stud 106 without disturbing or rotating the rail-clip 108.

Further, at step 608, a portion of the rail 112 is coupled to the elevating unit 107. The rail 112 includes two parallel beams 130, 132 that are snapped into the rail-clip 108. The wedges 136, 138 of the parallel beams 130, 132 slip or slide over the protruding portions 126, 128 of the rail-clip 108 and thereafter the parallel beams 130, 132 are mounted on the ridged portions 148, 150 of the rail-clip 108. It may also be noted that in certain embodiments, the parallel beams 130, 132 may be mounted on the base-wall 120 of the rail-clip 108.

Upon assembling the mounting system 100, at step 610, the fastener 110 is used to adjust the height of the mounting system 100. The fastener 110 is rotated and translated along the stud 106. This consequently varies the height of the rail-clip 108 and the rail 112 mounted on the rail-clip 108 relative to the mounting surface 102. Thus, by rotating the fastener 110, the photovoltaic modules 144, 146 disposed on the rail 112 may be laterally moved in the Z-direction.

The mounting system and the method for assembling the mounting system described hereinabove aid in reducing the manufacture cost and the labor cost for the installation of photovoltaic modules. Also, by employing fewer components in the mounting system, the installation time may be substantially reduced. Moreover, the mounting system facilitates tool-less adjustment of height of photovoltaic modules from a mounting surface, thereby allowing leveling of the photovoltaic modules and easy installation of the photovoltaic modules on an uneven roof surface.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A mounting system, comprising:
a support platform configured to fasten the mounting system to a mounting surface;
a stud operatively coupled to the support platform and disposed substantially perpendicular to the support platform;
an elevating unit operatively coupled to the stud, wherein the elevating unit comprises:
a fastener operatively coupled to one end of the stud and configured to vary a height of the mounting system;
a rail-clip coupled to the fastener, wherein a rotational motion of the rail-clip is independent of a rotational motion of the fastener; and
a rail operatively coupled to the rail-clip and configured to support at least one module.

2. The mounting system of claim 1, wherein the elevating unit further comprises a snap ring disposed along a circumference of an aperture in the rail-clip and configured to allow the rotational motion of the rail-clip that is independent of the rotational motion of the fastener.

3. The mounting system of claim 1, wherein the elevating unit is configured to vary the height of the mounting system independent of the coupling of the rail to the rail-clip.

4. The mounting system of claim 1, wherein the support platform further comprises:
a first joint configured to be inserted into the mounting surface through a first aperture of the support platform; and
a second joint configured to be inserted into the mounting surface through a second aperture of the support platform.

5. The mounting system of claim 4, wherein the stud is disposed at the center of the support platform between the first aperture and the second aperture.

6. The mounting system of claim 1, wherein the rail-clip further comprises:
a base-wall comprising an aperture aligned with a cavity of the fastener; and
a pair of side walls, wherein each side wall comprises a protruding portion, a ridged portion, or both the protruding portion and the ridged portion.

7. The mounting system of claim 6, wherein the stud is configured to protrude through the cavity of the fastener and the aperture in the base-wall when the fastener is rotated on the stud.

8. The mounting system of claim 6, wherein the rail-clip is configured to slide the rail over a track area of the rail-clip along a direction perpendicular to the stud.

9. The mounting system of claim 8, wherein the track area comprises at least an area between the protruding portion and the ridged portion of each side wall of the rail-clip.

10. The mounting system of claim 6, wherein the rail comprises:
at least two parallel beams configured to mate with the rail-clip; and
at least an I-beam configured to support the at least one module.

11. The mounting system of claim 10, wherein the at least two parallel beams comprise:
a first beam having a first wedge configured to couple with the protruding portion on one side wall of the rail-clip; and
a second beam having a second wedge configured to couple with the protruding portion on the other side wall of the rail-clip.

12. The mounting system of claim 1, wherein the elevating unit is configured to translate the rail in at least one of a lateral direction and a longitudinal direction.

13. The mounting system of claim 1, wherein the fastener is configured to be rotated over the stud to adjust the height of the mounting system.

14. A method for assembling a mounting system, the method comprising:
fastening a support platform to a mounting surface;
disposing a stud on the support platform such that the stud is disposed substantially perpendicular to the support platform;
coupling an elevating unit to one end of the stud, wherein the elevating unit comprises:
a fastener operatively coupled to the stud;
a rail-clip coupled to the fastener, wherein a rotational motion of the rail-clip is independent of a rotational motion of the fastener;
coupling at least a portion of a rail to the elevating unit; and
adjusting, by the fastener, a height of the mounting system independent of the coupling of the portion of the rail to the elevating unit.

15. The method of claim 14, wherein fastening the support platform to the mounting surface comprises:
inserting a first joint through a first aperture in the support platform to fasten the support platform to the mounting surface; and
inserting a second joint through a second aperture in the support platform to fasten the support platform to the mounting surface.

16. The method of claim 14, wherein adjusting, by the fastener, the height of the mounting system comprises rotating the fastener over the stud to protrude the stud through an aperture of the rail-clip.

17. The method of claim 16, wherein coupling at least the portion of the rail to the elevating unit comprises:
detachably coupling a first beam of the rail to the rail-clip to lock a first wedge of the first beam with a first protruding portion of the rail-clip; and
detachably coupling a second beam of the rail to the rail-clip to lock a second wedge of the second beam with a second protruding portion of the rail-clip.

18. The method of claim 14, wherein coupling at least the portion of the rail to the elevating unit comprises inserting the portion of the rail into the rail-clip to allow at least one of a lateral movement and a longitudinal movement of the rail.

19. A mounting system for supporting an array of modules on a mounting surface, the mounting system comprising:
a support platform configured to fasten the mounting system to the mounting surface;
a stud having a first end and a second end, wherein the first end is coupled to the support platform such that the stud is disposed substantially perpendicular to the support platform;
an elevating unit coupled to the second end of the stud, wherein the elevating unit comprises:
a fastener operatively coupled to the second end of the stud, and configured to rotate on the stud to vary a height of the mounting system;
a rail-clip coupled to the fastener, wherein the rail-clip comprises an aperture that allows the stud to protrude through the elevating unit; and
a snap ring disposed along the circumference of the aperture in the rail-clip and configured to allow the rotational motion of the rail-clip that is independent of the rotational motion of the fastener; and
a rail operatively coupled to the rail-clip and configured to support the array of modules.

20. The mounting system of claim 19, wherein the elevating unit is configured to adjust the height of the mounting system when the rail supporting the array of modules is coupled to the rail-clip.
